(19) United States
(12) Patent Application Publication
(10) Pub. No.: US 2018/0151305 A1
(43) Pub. Date: May 31, 2018

(54) DYE-SENSITISED SOLAR CELL

(71) Applicant: Orion Co., Ltd., Gumi-si, Gyeongsangbuk-do (KR)

(72) Inventor: Jun Seok Park, Daegu (KR)

(21) Appl. No.: 15/577,284

(22) PCT Filed: Jun. 29, 2016
(86) PCT No.: PCT/KR2016/006956

§ 371 Date: Nov. 27, 2017

(30) Foreign Application Priority Data
Jun. 30, 2015 (KR) 10-2015-0092751

(51) Int. Cl. H01G 9/20

(52) U.S. Cl. CPC H01G 9/2077; H01G 9/2027; H01G 9/2022

(57) ABSTRACT

A dye-sensitised solar cell according to the present invention allows a remaining sector of an undamaged partition wall or remaining arranged partition walls to perform their original role normally even though a part of a sector of a partition wall that has been divided by partition wall division slits or a part of partition walls that are consecutively arranged is damaged due to an increase in the volume of the electrolyte resulting from a temperature rise and an increase in the pressure inside an electrolyte accommodation cell resulting from the increase in the volume of the electrolyte by additionally forming the partition division slits inside the partition wall separating electrolyte accommodation cells capable of dividing the corresponding partition wall into a plurality of sectors, or by consecutively arranging the plurality of partition walls, and can thereby solve various problems resulting from damage of a partition wall.

### TECHNICAL FIELD

The present disclosure relates to a dye-sensitized solar cell, and more particularly, to a dye-sensitized solar cell in which a partition wall division slit is additionally formed in a partition wall to divide the corresponding partition wall into a plurality of sectors, or a plurality of partition walls is consecutively arranged between an upper plate and a lower plate, so that even though a certain sector of the partition wall divided by the partition wall division slit is damaged or a certain partition wall of the consecutively arranged partition walls is damaged due to an increase in the volume of an electrolyte caused by a temperature rise and a consequential increase in the pressure inside an electrolyte accommodation cell, the remaining undamaged sector of the partition wall or the remaining partition wall normally performs an original role of the partition wall (for example, isolating the electrolyte, connecting the upper plate and the lower plate, and the like), thereby solving many problems resulting from damage of the partition wall, for example, the electrolyte within the electrolyte accommodation cell invades an adjacent electrolyte accommodation cell through a tiny gap, causing the plurality of electrolyte accommodation cells to be incorporated into the same potential, or the electrolyte flowing out toward a grid electrode through a tiny gap contacts the corresponding grid electrode, causing a change in the properties of the grid electrode.

### BACKGROUND ART

As shown in FIG. 1, a conventional series-type dye-sensitized solar cell 10 may include upper and lower plates 11, 12 made of glass with upper and lower electrodes 15, 16, a plurality of electrolyte accommodation cells 14 arranged between the upper and lower plates 11, 12, each arrangement separated from each other by partition walls 13 positioned on two sides, and a grid electrode 17 interposed between the partition walls 13 and separated from an electrolyte by the partition walls 13. In this case, the upper and lower plates 11, 12 may be coated with a conductive material (not shown), for example, FTO.

A further detailed structure of the conventional series-type dye-sensitized solar cell 10 is disclosed by, for example, Korean Patent No. 10-1032916 (titled dye-sensitized solar cell series structure cell) (published May 6, 2011) and Korean Patent Publication No. 10-2014-3681 (titled series-type dye-sensitized solar cell module) (published Jan. 10, 2014).

Meanwhile, as shown in FIG. 2, a conventional parallel-type dye-sensitized solar cell 20 may include upper and lower plates 21, 22 made of glass with upper and lower electrodes 25, 26, a plurality of electrolyte accommodation cells 24 arranged between the upper and lower plates 21, 22, each arrangement separated from each other by partition walls 23 positioned on two sides, and upper and lower grid electrodes 27, 28 interposed between the partition walls 23 and separated from an electrolyte by the partition walls 23, the upper and lower grid electrodes 27, 28 being electrically separated from each other by an insulator 29 (for example, an insulating adhesive material). In this case, the upper and lower plates 21, 22 may be also coated with a conductive material (not shown), for example, FTO.

A further detailed structure of the conventional parallel-type dye-sensitized solar cell 20 is disclosed by, for example, Korean Patent No. 10-1002398 (titled series/parallel combination-type dye-sensitized solar cell module) (published Dec. 21, 2010) and Korean Patent No. 10-1119044 (titled parallel-type dye-sensitized solar cell module) (published Mar. 16, 2012).

The partition walls 13, 23 may play a role in partitioning each electrolyte accommodation cell 14, 24, a role in insulating the upper and lower plates 11, 12, 21, 22, and a role in uniformly maintaining the distance between the upper and lower plates 11, 12, 21, 22.

Meanwhile, because the electrolyte accommodated in the electrolyte accommodation cell 14, 24 is in liquid state, when the temperature rises, the volume increases in proportion thereto. When the volume of the electrolyte increases due to this temperature rise, the pressure inside the electrolyte accommodation cell 14, 24 also increases in proportion thereto, and when an increase in the pressure inside the electrolyte accommodation cell 14, 24 continues, the partition wall 13, 23 partitioning the electrolyte accommodation cells 14, 24 may be damaged, as a consequence, causing a serious problem that a tiny gap is formed between the partition wall 13, 23 and the upper and lower plates 11, 12, 21, 22.

Due to this phenomenon, when the partition wall 13, 23 is damaged, as a consequence, forming a tiny gap between the partition wall partition wall 13, 23 and the upper and lower plates 11, 12, 21, 22, serious problems may occur, for example, the electrolyte within the electrolyte accommodation cell 14, 24 invades an adjacent electrolyte accommodation cell 14, 24 through the tiny gap, causing the plurality of electrolyte accommodation cells 14, 24 to be incorporated into the same potential, or the electrolyte within the electrolyte accommodation cell 14, 24 flows out toward the grid electrode 17, 27, 28 through the tiny gap and contacts the corresponding grid electrode 17, 27, 28, causing a change in the properties of the grid electrode 17, 27, 28.

### DISCLOSURE

### Technical Problem

To solve the above problems, the present disclosure aims to additionally form a partition wall division slit in a partition wall to divide the corresponding partition wall into a plurality of sectors, or consecutively arrange a plurality of partition walls between an upper plate and a lower plate, so that even though a certain sector of the partition wall divided by the partition wall division slit is damaged or a certain partition wall of the consecutively arrange partition walls is damaged due to an increase in the volume of an electrolyte caused by a temperature rise and a consequential increase in the pressure inside an electrolyte accommodation cell, the remaining undamaged sector of the partition wall or the remaining arranged partition wall normally performs an original role of the partition wall (for example, isolating electrolyte, connecting an upper plate and a lower plate, and the like).

According to the embodiments of the present disclosure, many problems caused by damage in the partition wall can be solved, for example, a serious problem that the electrolyte within the electrolyte accommodation cell invades an adjacent electrolyte accommodation cell through a tiny gap, causing the plurality of electrolyte accommodation cells to be incorporated into the same potential, or a serious problem that the electrolyte flowing out toward a grid electrode through a tiny gap contacts the corresponding grid electrode, causing a change in the properties of the grid electrode.

### Technical Solution

To achieve the above object of the present disclosure, a dye-sensitized solar cell according to an embodiment includes an upper plate and a lower plate, a plurality of electrolyte accommodation cells arranged between the upper plate and the lower plate, each electrolyte accommodation cell being separated from each other by partition walls positioned on two sides, and a grid electrode placed between the partition walls separating each electrolyte accommodation cell from each other, and separated from an electrolyte by the partition wall, wherein a partition wall division slit is formed in each partition wall to divide the partition wall into a plurality of sectors.

A dye-sensitized solar cell according to an embodiment of the present disclosure includes an upper plate and a lower plate, a plurality of electrolyte accommodation cells arranged between the upper plate and the lower plate, each electrolyte accommodation cell being separated from each other by partition walls positioned on two sides, and an upper grid electrode and a lower grid electrode placed between the partition walls separating each electrolyte accommodation cell from each other, and separated from an electrolyte by the partition wall, the upper grid electrode and the lower grid electrode being electrically separated from each other by an insulator, wherein a partition wall division slit is formed in each partition wall to divide the partition wall into a plurality of sectors.

A dye-sensitized solar cell according to an embodiment of the present disclosure includes an upper plate and a lower plate, a plurality of electrolyte accommodation cells arranged between the upper plate and the lower plate, each electrolyte accommodation cell being separated from each other by partition walls positioned on two sides, and a grid electrode between the partition walls separating each electrolyte accommodation cell from each other, and separated from an electrolyte by the partition walls, wherein the plurality of partition walls is consecutively arranged between the upper plate and the lower plate.

A dye-sensitized solar cell according to an embodiment of the present disclosure includes an upper plate and a lower plate, a plurality of electrolyte accommodation cells arranged between the upper plate and the lower plate, each electrolyte accommodation cell being separated from each other by partition walls positioned on two sides, and an upper grid electrode and a lower grid electrode placed between the partition walls separating each electrolyte accommodation cell from each other, and separated from an electrolyte by the partition walls, the upper grid electrode and the lower grid electrode being electrically separated from each other by an insulator, wherein the plurality of partition walls is consecutively arranged between the upper plate and the lower plate.

In an embodiment, the partition wall has any one material of frit glass, epoxy, silicon, urethane and surlyn.

### Advantageous Effects

According to the embodiments of the present disclosure, a partition wall division slit is additionally formed in a partition wall of a dye-sensitized solar cell to divide the corresponding partition wall into a plurality of sectors, or a plurality of partition walls is consecutively arranged between an upper plate and a lower plate. Accordingly, even though a certain sector of the partition wall divided by the partition wall division slit is damaged, or a certain partition wall of the consecutively arranged partition walls is damaged due to an increase in volume of an electrolyte within an accommodation cell caused by a temperature rise and a consequential significant increase in pressure inside the electrolyte accommodation cell, the remaining undamaged sector of the partition wall or the remaining arranged partition wall can normally perform an original role of the partition wall (for example, isolating the electrolyte, connecting the upper plate and the lower plate, and the like).

Accordingly, many problems caused by damage in the partition wall can be solved, for example, problem that the electrolyte within the electrolyte accommodation cell invades an adjacent electrolyte accommodation cell through a tiny gap, causing the plurality of electrolyte accommodation cells to be incorporated into the same potential, or problem that the electrolyte flowing out toward a grid electrode through a tiny gap contacts the corresponding grid electrode, causing a change in the properties of the grid electrode.

### DESCRIPTION OF DRAWINGS

FIG. 1 is a diagram showing an example of a conventional series-type dye-sensitized solar cell.

FIG. 2 is a diagram showing an example of a conventional parallel-type dye-sensitized solar cell.

FIGS. 3 and 5 are diagrams showing an example of a series-type dye-sensitized solar cell according to an embodiment of the present disclosure.

FIGS. 4 and 6 are diagrams showing an example of a parallel-type dye-sensitized solar cell according to an embodiment of the present disclosure.

FIG. 7 is a diagram showing an example of a series-type dye-sensitized solar cell according to another embodiment of the present disclosure.

FIG. 8 is a diagram showing an example of a parallel-type dye-sensitized solar cell according to another embodiment of the present disclosure.

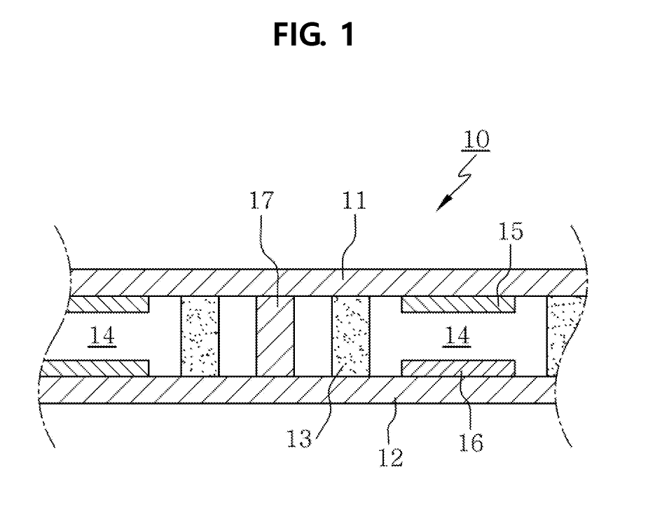

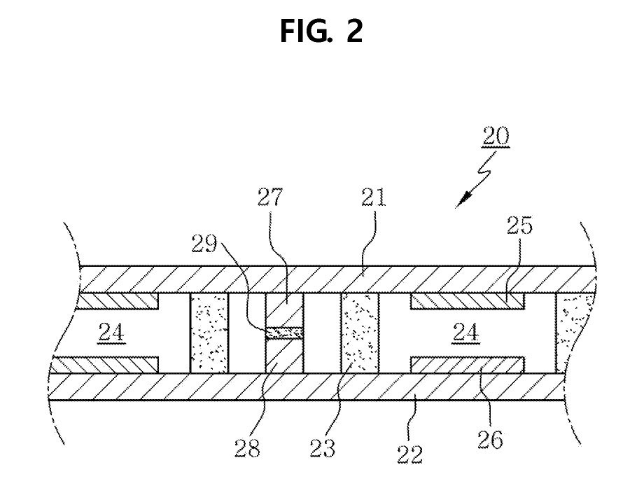

### BEST MODE

Hereinafter, a dye-sensitized solar cell according to the present disclosure will be described in detail below with reference to the accompanying drawings.

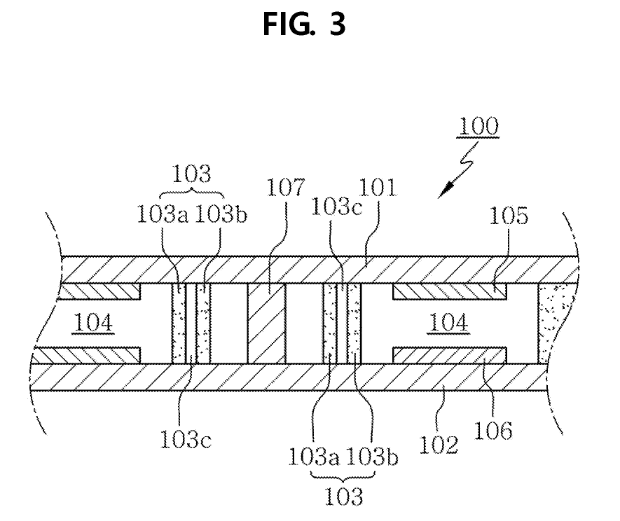

FIG. 3 is a diagram showing a cross section of a dye-sensitized solar cell 100 according to an embodiment, and shows electrolyte accommodation cells 104 arranged between an upper plate 101 and a lower plate 102, and partition walls 103 and a grid electrode 107 interposed therebetween. As shown, the series-type dye-sensitized solar cell 100 according to an embodiment of the present disclosure may include upper and lower plates 101, 102 made of glass with upper and lower electrodes 105, 106, a plurality of electrolyte accommodation cells 104 arranged between the upper and lower plates 101, 102, each arrangement separated from each other by partition walls 103 positioned on two sides, and a grid electrode 107 interposed between the partition walls 103 separating each electrolyte accommodation cell 104 from each other, and separated from an electrolyte by the partition walls 103.

In this case, the upper and lower plates 101, 102 may be coated with a conductive material (not shown), for example, FTO. In an embodiment, the partition walls 103 may play a role in partitioning each electrolyte accommodation cell 104, a role in insulating the upper and lower plates 101, 102, and a role in uniformly maintaining the distance between the upper and lower plates 101, 102.

In an embodiment, each electrolyte accommodation cell 104 may have a structure in which the upper/lower/side surfaces are respectively surrounded by the upper and lower plates 101, 102 and the partition walls 103, and in this case, the partition wall 103 may play a role in separating an electrolyte within the accommodation cell to prevent the electrolyte from flowing outward. In an embodiment, the grid electrode 107 may be placed for each arrangement of the electrolyte accommodation cells 104. In this case, each grid electrode 107 may be placed between the partition walls 103 positioned on two sides of the electrolyte accommodation cell 104.

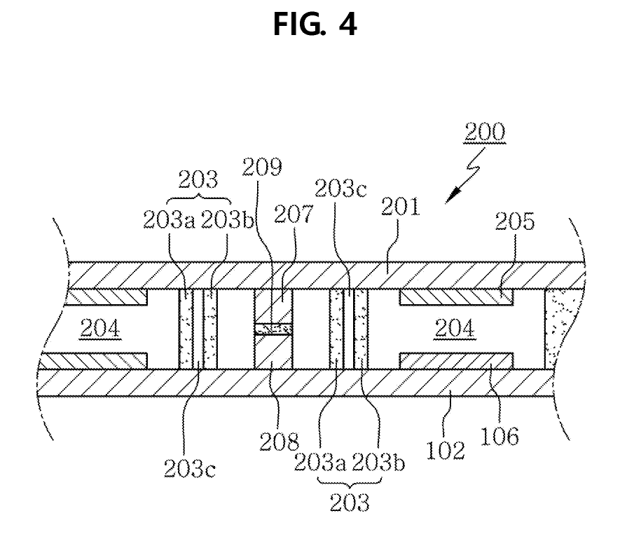

Furthermore, FIG. 4 is a diagram showing a cross section of a dye-sensitized solar cell 200 according to an embodiment, and shows electrolyte receiving cells 204 arranged between an upper plate 201 and a lower plate 202, and partition walls 203 and upper/lower grid electrodes 207, 208 interposed therebetween. As shown, the parallel-type dye-sensitized solar cell 200 according to an embodiment of the present disclosure may include upper and lower plates 201, 202 made of glass with upper and lower electrodes 205, 206, a plurality of electrolyte accommodation cells 204 arranged between the upper and lower plates 201, 202, each arrangement separated from each other by partition walls 203 positioned on two sides, and upper and lower grid electrodes 207, 208 interposed between the partition walls 203 separating each electrolyte accommodation cell 204 from each other and separated from an electrolyte by the partition walls 203, the upper and lower grid electrodes 207, 208 being electrically separated from each other by an insulator 209 (for example, an insulating adhesive material).

In this case, the upper and lower plates 201, 202 also may be coated with a conductive material (not shown), for example, FTO. In an embodiment, the partition walls 203 may play a role in partitioning each electrolyte accommodation cell 204, a role in insulating the upper and lower plates 201, 202, and a role in uniformly maintaining the distance between the upper and lower plates 201, 202.

In an embodiment, each electrolyte accommodation cell 204 may have a structure in which the upper/lower/side surfaces are respectively surrounded by the upper and lower plates 201, 202 and the partition walls 203, and in this case, the partition wall 203 may play a role in separating an electrolyte within the accommodation cell to prevent the electrolyte from flowing outward. In an embodiment, the upper and lower grid electrodes 207, 208 may be placed in each space between the partition walls 203 positioned on two sides.

Meanwhile, in the above structure, because the electrolyte accommodated in the electrolyte accommodation cell 104, 204 is also in liquid state, when the temperature rises, the volume increases in proportion thereto. When the volume of the electrolyte increases due to this temperature rise, the pressure inside the electrolyte accommodation cell 104, 204 also increases in proportion thereto, and when an increase in the pressure inside the electrolyte accommodation cell 104, 204 continues, the partition wall 103, 203 partitioning the electrolyte accommodation cells 104, 204 may be damaged, as a consequence, causing a serious problem that a tiny gap is formed between the partition wall 103, 203 and the upper and lower plates 101, 102, 201, 202.

Due to this phenomenon, when the partition wall 103, 203 is damaged, as a consequence, forming a tiny gap between the partition wall 103, 203 and the upper and lower plates 101, 102, 201, 202, serious problems may occur, for example, the electrolyte within the electrolyte accommodation cell 104, 204 invades an adjacent electrolyte accommodation cell 104, 204 by the medium of the tiny gap, causing the plurality of electrolyte accommodation cells 104, 204 to be incorporated into the same potential, or the electrolyte within the electrolyte accommodation cell 104, 204 flows out toward the grid electrode 107, 207, 208 by the medium of the tiny gap and contacts the corresponding grid electrode 107, 207, 208, causing a change in the properties of the grid electrode 107, 207, 208.

To solve the above problems, in an embodiment, a partition wall division slit 103c, 203c may be additionally formed in the partition wall 103, 203 to divide the corresponding partition wall 103, 203 into a plurality of sectors 103a, 103b, 203a, 203b as shown in FIGS. 3 and 4.

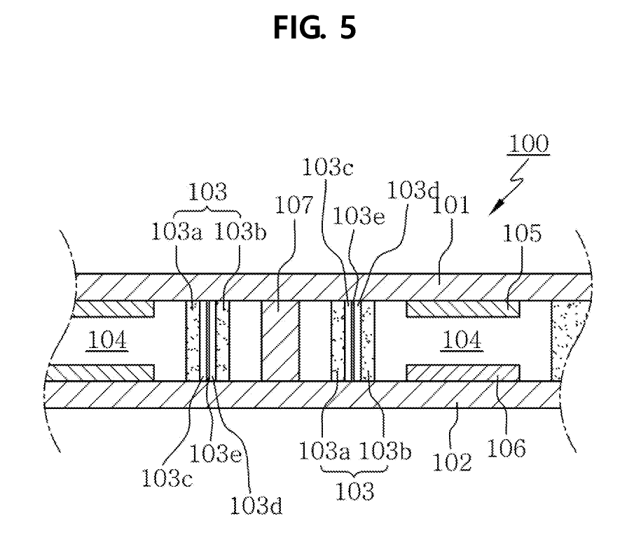

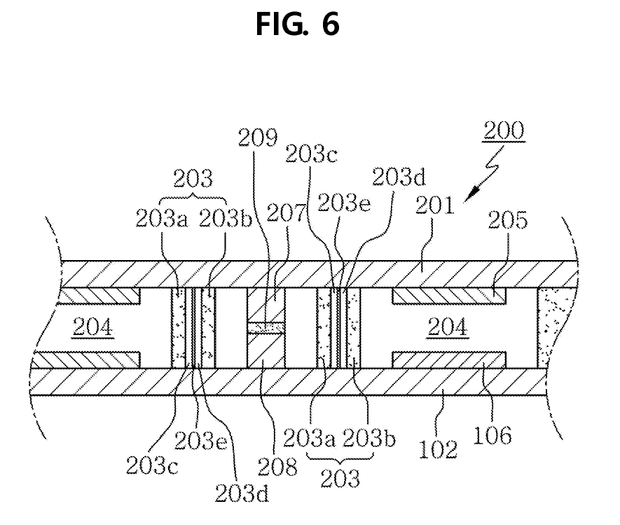

Further, in an embodiment, a larger number of partition wall division slits 103c, 103d, 203c, 203d may be formed to divide the partition wall 103, 203 into smaller sectors 103a, 103b, 103e, 203a, 203b, 203e as shown in FIGS. 5 and 6. When the partition wall is divided into smaller sectors, the partition wall can endure the expansion caused by an increase in the pressure inside of the accommodation cell more flexibly, and even though a certain sector of the partition wall is damaged, the outflow/inflow of the electrolyte can be prevented by the remaining sectors more safely.

In an embodiment, the partition wall 103, 203 may be preferably made of any one material of frit glass, epoxy, silicon, urethane and surlyn, but is not limited thereto.

According to the above embodiments, as the partition wall division slit 103c, 203c is additionally formed in the partition wall 103, 203 of the dye-sensitized solar cell to divide the corresponding partition wall 103, 203 into the plurality of sectors 103a, 103b, 203a, 203b, even though a certain sector 103a, 203a of the partition wall 103, 203 divided by the partition wall division slit 103c, 203c is damaged due to an increase in the volume of the electrolyte caused by a temperature rise and a consequential increase in the pressure inside the electrolyte accommodation cell 104, 204, a certain remaining sector 103b, 203b of the partition wall 103, 203 normally performs an original role of the partition wall (for example, isolating electrolyte, connecting an upper plate and a lower plate, and the like).

Accordingly, serious problems can be solved, for example, the electrolyte within the electrolyte accommodation cell 104, 204 invades an adjacent electrolyte accommodation cell 104, 204 through the tiny gap, causing the plurality of electrolyte accommodation cells 104, 204 to be incorporated into the same potential, or the electrolyte within the electrolyte accommodation cell 104, 204 flows out toward the grid electrode 107, 207, 208 through the tiny gap and contacts the grid electrode 107, 207, 208, causing a change in the properties of the corresponding grid electrode 107, 207, 208.

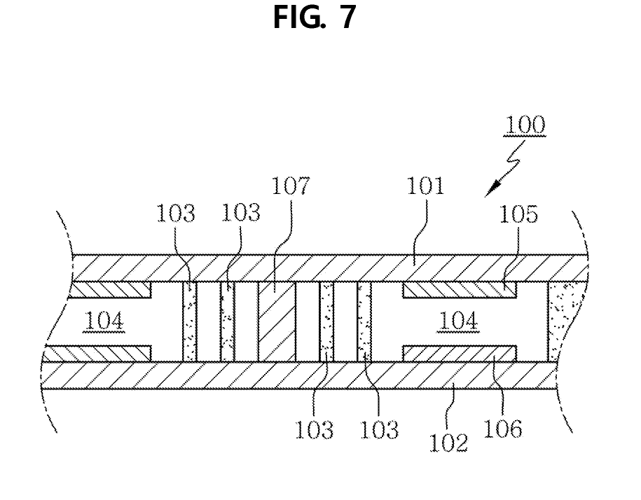

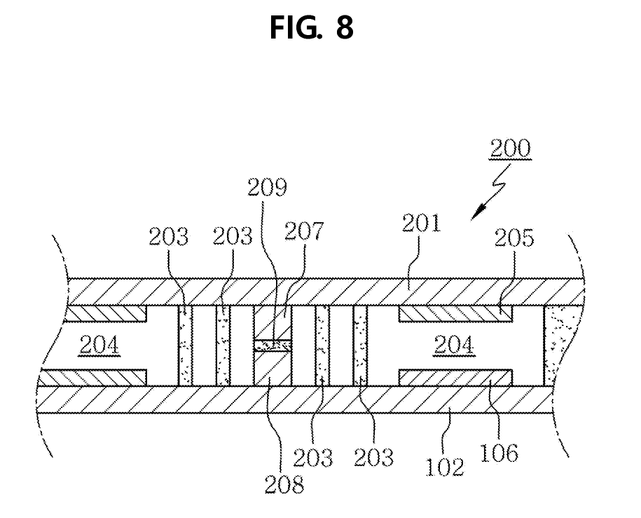

Meanwhile, as shown in FIGS. 7 and 8, in another embodiment of the present disclosure, a plurality of partition walls 103, 203 may be consecutively arranged between the upper plate and the lower plate. In an embodiment, the plurality of consecutively arranged partition walls may be consecutively arranged between the electrolyte accommodation cell 104, 204 and the grid electrode 107, 207, 208.

In this case, the partition wall 103, 203 may be also preferably made of any one material of frit glass, epoxy, silicon, urethane and surlyn, but is not limited thereto.

According to the above embodiment, even though a certain partition wall of the consecutively arranged partition walls is damaged due to an increase in the volume of the electrolyte caused by a temperature rise and a consequential increase in the pressure inside the electrolyte accommodation cell 104, 204, the remaining arranged partition wall normally performs an original role of the partition wall (for example, isolating the electrolyte, connecting the upper plate and the lower plate, and the like), thereby solving a serious problem that the electrolyte within the electrolyte accommodation cell 104, 204 invades an adjacent electrolyte accommodation cell 104, 204 through a tiny gap, causing the plurality of electrolyte accommodation cells 104, 204 to be incorporated into the same potential, or a problem that the electrolyte within the electrolyte accommodation cell 104, 204 flows out toward the grid electrode 107, 207, 208 through a tiny gap and contacts the grid electrode 107, 207, 208, causing a change in the properties of the corresponding grid electrode 107, 207, 208.

The present disclosure is not limited to a particular field, and generally exerts useful effects in many fields requiring prevention of damage in a partition wall.

While the present disclosure have been hereinabove described with reference to the embodiments shown in the drawings, this is for illustrative purposes only and it will be understood by those skilled in the art that various modifications in form and details may be made thereto. However, it should be noted that such modifications fall within the technical scope of protection of the present disclosure. Therefore, the true technical scope of protection of the present disclosure should be defined by the technical spirit of the appended claims.

### INDUSTRIAL APPLICABILITY

The dye-sensitized solar cell according to the embodiments of the present disclosure includes the partition wall division slit additionally formed in the partition wall to divide the corresponding partition wall into the plurality of sectors, or the plurality of partition walls consecutively arranged between the upper plate and the lower plate, so that even though a certain sector of the partition wall or a certain partition wall of the consecutively arranged partition walls is damaged due to an increase in the volume of the electrolyte within the accommodation cell and a consequential increase in the pressure inside the electrolyte accommodation cell, the remaining undamaged sector of the partition wall or the remaining partition wall normally performs an original role of the partition wall (for example, isolating the electrolyte, connecting the upper plate and the lower plate, and the like). At the side of manufacturers, various problems that may occur during the process or use can be overcome by preventing the electrolyte from flowing inward/outward through a gap of the damaged partition wall by virtue of this structural feature.

1. A dye-sensitized solar cell, comprising:
an upper plate and a lower plate;
a plurality of electrolyte accommodation cells arranged between the upper plate and the lower plate, each electrolyte accommodation cell being separated from each other by partition walls positioned on two sides; and
a grid electrode placed between the partition walls separating each electrolyte accommodation cell from each other, and separated from an electrolyte by the partition walls,
wherein a partition wall division slit is formed in each partition wall to divide the partition wall into a plurality of sectors.

2. A dye-sensitized solar cell, comprising:
an upper plate and a lower plate;
a plurality of electrolyte accommodation cells arranged between the upper plate and the lower plate, each electrolyte accommodation cell being separated from each other by partition walls positioned on two sides; and
an upper grid electrode and a lower grid electrode placed between the partition walls separating each electrolyte accommodation cell from each other, and separated from an electrolyte by the partition walls, the upper grid electrode and the lower grid electrode being electrically separated from each other by an insulator,
wherein a partition wall division slit is formed in each partition wall to divide the partition wall into a plurality of sectors.

3. A dye-sensitized solar cell, comprising:
an upper plate and a lower plate;
a plurality of electrolyte accommodation cells arranged between the upper plate and the lower plate, each electrolyte accommodation cell being separated from each other by partition walls positioned on two sides; and
a grid electrode between the partition walls separating each electrolyte accommodation cell from each other, and separated from an electrolyte by the partition walls,
wherein the plurality of partition walls is consecutively arranged between the upper plate and the lower plate.

4. A dye-sensitized solar cell, comprising:
an upper plate and a lower plate;
a plurality of electrolyte accommodation cells arranged between the upper plate and the lower plate, each electrolyte accommodation cell being separated from each other by partition walls positioned on two sides; and
an upper grid electrode and a lower grid electrode placed between the partition walls separating each electrolyte accommodation cell from each other, and separated from an electrolyte by the partition walls, the upper grid electrode and the lower grid electrode being electrically separated from each other by an insulator,
wherein the plurality of partition walls is consecutively arranged between the upper plate and the lower plate.

5. The dye-sensitized solar cell according to claim 1, wherein the partition walls have any one material of frit glass, epoxy, silicon, urethane and surlyn.
